(19) United States
(12) Patent Application Publication
(10) Pub. No.: US 2007/0006819 A1
(43) Pub. Date: Jan. 11, 2007

(54) Safe-T-Chain

(75) Inventor: Lorri Jo Gilbert-Brindley, Los Molinos, CA (US)

Correspondence Address: LORRI JO GILBERT-BRINDLEY, 24781 TAFT STREET, LOS MOLLNOS, CA, 96055, US

(73) Assignee: Lorri Jo Gilbert-Brindley, Los Molinos, CA (US)

(21) Appl. No.: 11/160,760

(22) Filed: Jul. 7, 2005

(51) Int. Cl. A01K 27/00

(52) U.S. Cl. 119/771

(57) ABSTRACT

An animal restraint system for a pickup truck consisting of a chain of varying length (appropriate to size of vehicle bed), connected at both ends to sliding safety and swivel hooks, one pair of which is attached to a bolt and eyehook secured to the truck bed using washers and safety nuts, the other attached to the animal leash. Said restrain system allows the animal restricted side-to-side movement in the truck bed while preventing the animal from jumping over the side of the truck or out of the truck bed. Said restrain system is crash safe, as it secures animal to the bottom of the truck bed so the animal can not be thrown from the truck in a crash and will remain secured to the bed within safety range should the truck roll.

### BACKGROUND OF THE INVENTION

1. Field of the Invention

The present invention relates to animal restraints, and more particularly to animal restraint systems for vehicles.

2. Prior Art

Current restrain systems for truck beds attach from the side of the truck or the back of the cab, making it easy for animals to jump over the side of the vehicle or be thrown from the vehicle in the event of an accident.

The object of the current invention is to provide a restraint system for truck beds and open vehicles that attaches to the bottom of the bed and allows comfortable yet restricted movement without the possibility of the restrained animal jumping over the side of the vehicle or being thrown from the vehicle in an accident.

### SUMMARY OF THE INVENTION

The present invention remedies the problems associated with truck bed and open vehicle restraints that attach to the side of the truck bed, objects within the truck bed, or the cab of the truck, namely the likelihood that restrained animals will break free, be able to jump over the side of the vehicle, or be thrown from the vehicle in the event of an accident. The present invention is advantageous in that: (1) it attaches to the bottom of the truck bed, thereby providing a more secure connection to the truck bed which will withstand up to 1100 pounds of pressure with a 90% chance that the restrained animal will remain secured to the vehicle; (2) it works on a swivel hook, allowing the restrained animal freedom of movement from side to side, but not movement upward, thereby preventing the restrained animal from jumping from the vehicle; (3) it can be easily removed from the securing eye hook and used as an animal leash in the event of an emergency or if the restrained animal needs a brief walk after a long time in the vehicle bed.

### BRIEF DESCRIPTION OF THE SEVERAL VIEWS OF THE DRAWING

FIG. 1 illustrates and identifies the composition of the animal restraint system.

FIG. 2 is a cutaway of the secure connection to the truck bed.

FIG. 3 illustrates the movement of the chain when attached to the secure connection to truck bed.

FIG. 4 illustrated the connection of the animal restraint chain to the animal leash.

DRAWING REFERENCE NUMERALS 1. Truck bed 2. Bolt and eyehook 3. Swivel hook attached to truck bed connector 4. Chain of varying length (appropriate to size of vehicle bed) 5. Sliding safety hook 6. Eyehook 7. Top safety washer 8. Safety hook attached to animal collar 9. Bottom safety washer 10. Safety nuts.

### DETAILED DESCRIPTION OF THE INVENTION

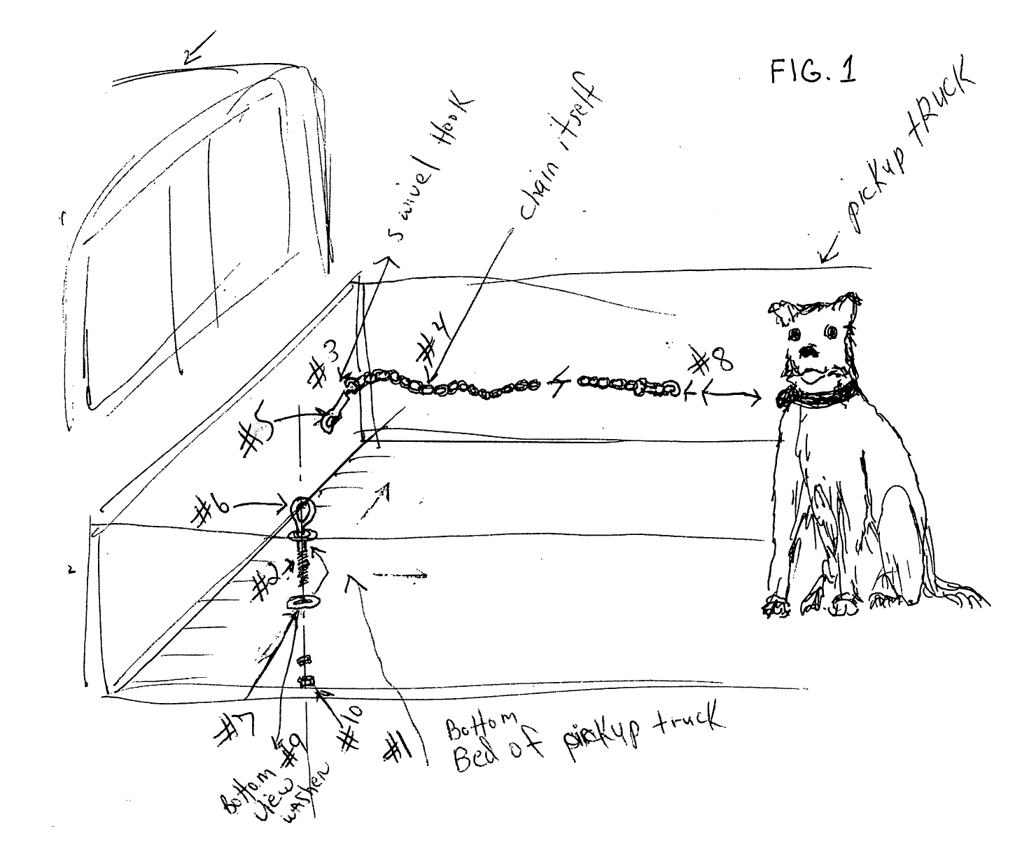

FIG. 1.

Is a pictorial representation of an animal restraint system intended for use in the bed of a truck or open vehicle. Said system features a bolt and eyehook 2 attached to the bottom bed of the vehicle 1 using a secure washer 9 fastened between two safety nuts 10 on the undercarriage of the vehicle and a washer 7 secured by a safety nut 10 on the top side of the vehicle bed. A detachable sliding safety hook 5 is attached to the eyehook 6 and secured to a chain of varying length 4 by a swivel hook 3. The chain of varying length 4 is attached at the other end to another sliding safety hook 5/swivel hook 3 which attaches to a safety hook on the restrained animal's collar 8.

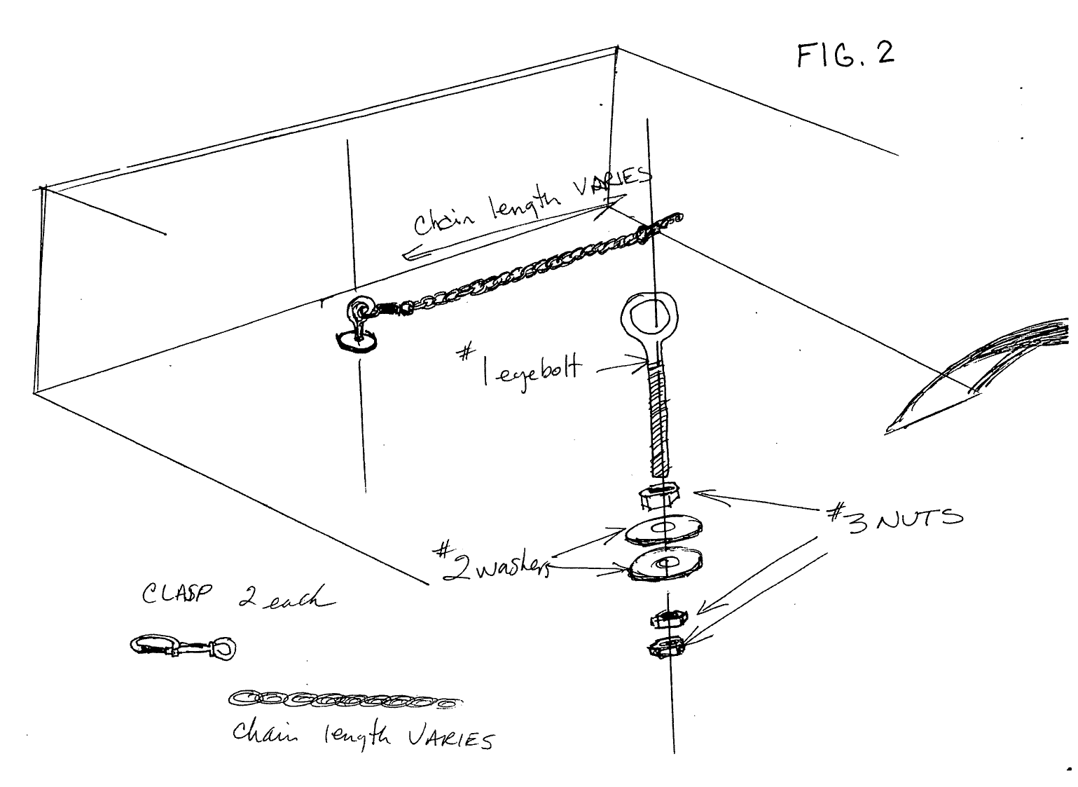

FIG. 2.

Shows the bolt and eyehook 2 secured to the bottom bed of the vehicle 1 using a secure washer 9 fastened between two safety nuts 10 on the undercarriage of the vehicle and a washer 7 secured by a safety nut 10 on the top side of the vehicle bed.

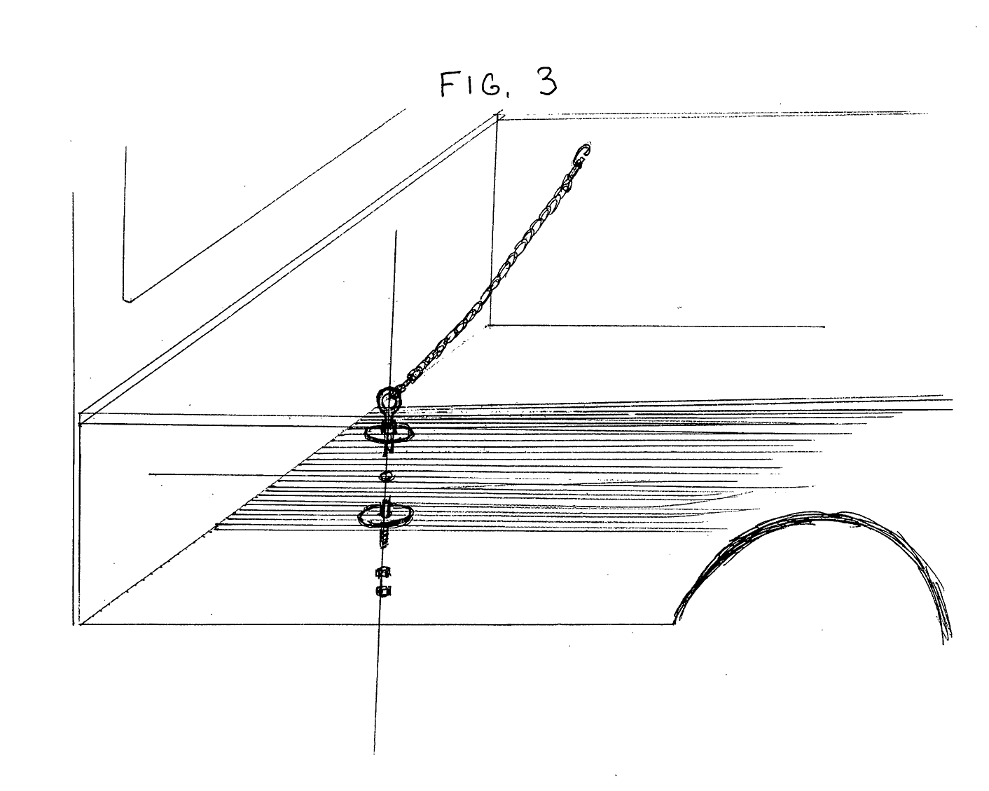

FIG. 3.

Shows the detachable sliding safety hook 5 attached to the eyehook 6 and secured to a chain of varying length 4 by a swivel hook 3.

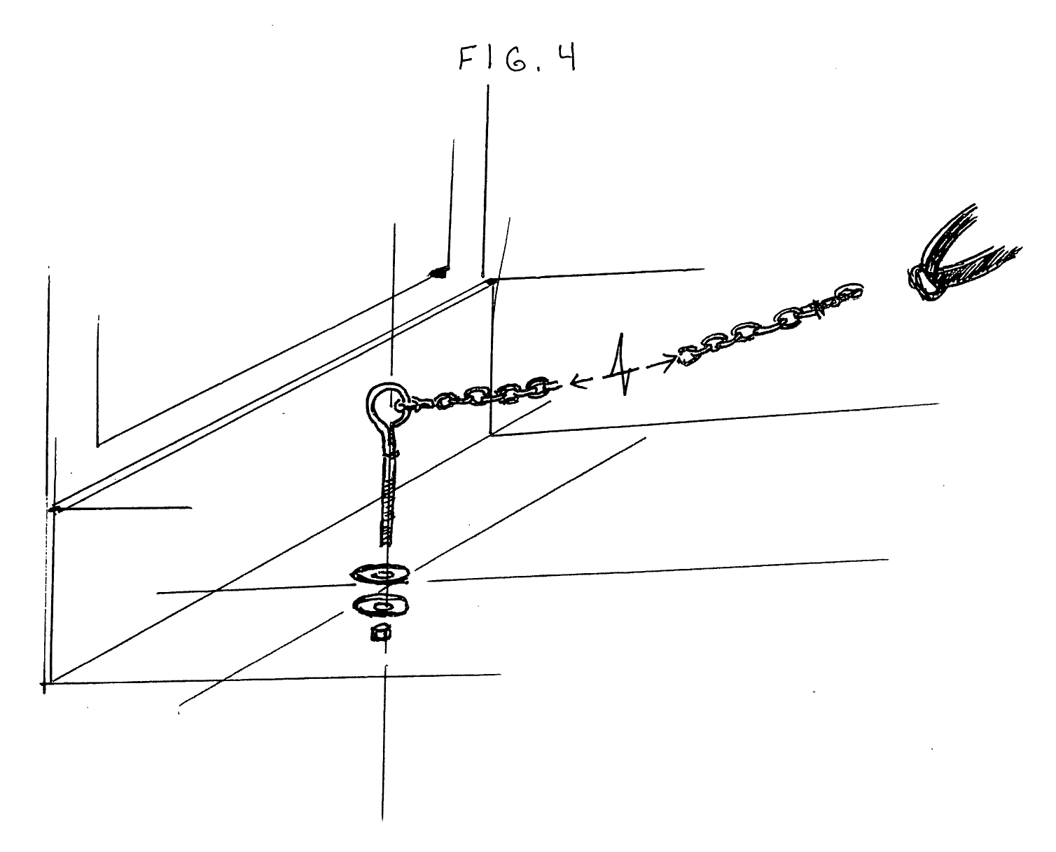

FIG. 4.

Shows the detachable sliding safety hook 5 attached to the eyehook 6 and secured to the chain of varying length 4 by a swivel hook 3 and the chain of varying length 4 attached to another sliding safety hook 5/swivel hook 3 which is attached to a safety hook on the restrained animal's collar 8.

1. An animal restraint system for use in truck beds or open vehicles comprising a chain of varying length with a sliding safety hook/swivel hook combination at each end, with one end attached to a bolt and eyehook secured to the bottom of the bed of a vehicle using a washer and safety nut on the top side of the vehicle bed and a washer and two safety nuts on the undercarriage of the vehicle bed and the other end attachable to the collar of the restrained animal.

2. An animal restraint system according to claim 1 wherein the animal is secured to the bottom of the truck or vehicle bed.

3. (canceled)

4. (canceled)

5. (canceled)

6. An animal restraint system according to claim 1 wherein a secure chain of varying length comprises the basis of the restraint.

7. (canceled)

8. (canceled)

9. (canceled)

10. An animal restraint system according to claim 1 wherein the secured chain by merit of being attached to the bottom of the bed of the vehicle allows the restrained animal movement from side to side without the ability of jumping up and over the side of the vehicle.

11. An animal restraint system according to claim 1 wherein the secured chain by merit of being attached to the bottom of the bed of the vehicle will withstand up to 1100 pounds of pressure and provide 90% protection against the restrained animal being thrown from the vehicle in the event of an accident.

12. An animal restraining system according to claim 1 wherein the secured chain can be unattached from the vehicle and used as a leash for roadside walking in the event of emergencies.
